(19) United States
(12) Patent Application Publication
(10) Pub. No.: US 2025/0258406 A1
(43) Pub. Date: Aug. 14, 2025

(54) DISPLAY DEVICE WITH BACKLIGHT UNIT

(71) Applicant: Continental Automotive Technologies GmbH, Hannover (DE)

(72) Inventor: Cristian Gordan, Oradea (RO)

(73) Assignee: Continental Automotive Technologies GmbH, Hannover (DE)

(21) Appl. No.: 19/040,354

(22) Filed: Jan. 29, 2025

(30) Foreign Application Priority Data
Feb. 9, 2024 (EP) 24465503.1
Feb. 12, 2024 (GB) 2401865.7

(51) Int. Cl. G02F 1/13357

(52) U.S. Cl. CPC G02F 1/133606; G02F 1/133603; G02F 1/133615

(57) ABSTRACT

The present application relates to a display device and a vehicle comprising such display device. The display device comprises a housing, a backlight unit with a backlight LED working in the visible wavelength spectrum, placed in the housing, a light diffuser placed in front of the backlight unit, an LCD structure layer placed in front of the light diffuser and a cover glass placed in front of the LCD structure layer. The backlight unit further comprises an infrared LED placed in a similar manner in the display device as the backlight LED.

### CROSS REFERENCE TO RELATED APPLICATIONS

This US patent application claims the benefit of European patent application No. 24465503.1, filed Feb. 9, 2024, and United Kingdom patent application No. 2401865.7, filed Feb. 12, 2024, both of which are hereby incorporated by reference.

### TECHNICAL FIELD

The present application relates to a display device with a backlight unit and a vehicle with such integrated display.

### BACKGROUND

From the state-of-the-art liquid crystal displays (LCD: liquid-crystal displays) are known as opto-electronic devices which are widely spread in various devices like smartphones, tablets, tv's and nowadays more and more extensive in the automotive industry.

In vehicles, displays are used for providing a driver with critical information regarding the parameters of the vehicle, such as for example speed, navigation, etc., and have also multimedia usage for passengers in the vehicle. An example of a structure of an LCD device known from the state of the art can be seen in FIG. 1. Such an LCD device 1 is usually composed of several parts, such as a housing 2, a backlight unit with a light source, here a backlight LED 10 working in the visible spectrum, a light diffuser 4, light polarizers 5, 6, a thin-film-transistor (TFT: thin-film-transistor) matrix 7, a liquid crystal structure layer 8 which is basically just an electronic controlled filter, a colour filter 12 and a cover glass 9.

There are mainly two technologies known for usage as light source in the LCD; cold cathode fluorescent lamps (CCFL: cold cathode fluorescent lamp) and light-emitting diodes (LED: light-emitting diode) working in the visible range. Meanwhile it has been established to use LEDs working in the visible range, e.g., a white LED strip, as backlight, since CCFLs technology becomes more and more obsolete and is not used in the automotive industry anymore.

To ensure an even distribution of generated light on the whole surface of an active area of the display, the light diffuser, also referred to as light guide, is used. The light diffuser must have a specific diffusion parameter and it must also maintain its mechanical and optical performances at high temperatures.

Before the light gets to the thin-film-transistor (TFT) matrix, commonly it passes through a first polarizer filter, called back polarizer. The polarizers are made from crystalline materials, having a specific transmittance index and their purpose is to allow only specific polarizations of the light to pass. This is necessary because of how the liquid crystal's geometry and how they work, by shifting the polarity of the light. The thin-film-transistor matrix or simply TFT matrix, is basically an array of individually addressable cells, which are commonly known as pixels. The liquid crystal structure is an optical filter which is electronically controlled in order to let specific wavelengths of light to pass and exclude others. The cover glass has aesthetical and mechanical properties, it is the surface which is perceived by the user, and which will be used as an interactive surface. Such backlight systems for LCD devices are for example known from EP 1 801 637 A1 and US 2005/0083295 A1.

Furthermore, from the state of the art, Interior Camera Systems are known which actively target and track a driver's face to determine the behavior of the driver while driving a vehicle. These Interior Camera Systems are basically used as a safety feature to determine the driver's attentiveness, focus capabilities and other parameters through a camera sensor, which is usually placed somewhere close to a steering column. Such systems are for example known from US 2014/0097957 A1 and CN 103839379 A.

It is known to use an infrared (IR: infrared) LED to “illuminate” the driver's face, usually somewhere in the 850-940 nm wavelength range, and a sensor, e.g., a camera sensor, to constantly acquiring images, which are sent to a post-processing unit and which analyses received information of the acquired images. If the position of the IR LED is relatively “far” from the camera unit, the principle of the eye tracking detection is called “dark pupil tracking” because the pupil of the eye appears darker than the iris. If the IR LED is placed relatively “close” to the driver, the pupil center corneal reflection tracking is called “bright pupil tracking” because the pupil appears brighter than the iris.

Most of the “older” Interior Camera Systems are placed either on the steering wheel column, or somewhere in the close proximity of the driver, e.g., near a cluster instrument, or around the multimedia systems. These acquisition systems are inevitably bound to an acquisition system, which delivers the processed information via a CAN network in the vehicle. The new dashboard designs, on the other hand are very rapidly evolving, so that the Original Equipment Manufacturers (OEM: Original Equipment Manufacturer) are demanding a more “seamless” integration of all the elements which the driver is perceiving from behind the steering wheel. This kind of approach does not permit the sensors which are monitoring the driver and/or the cockpit to be placed in “obvious” places on or around the dashboard, but to integrate them somehow in the cluster instrument and/or in the multimedia system.

To have a proper illumination of the driver's face the infrared LED must be placed as close as possible to the driver and the position is usually chosen around the cluster instrument. The position also depends on what kind of detection is used, i.e., dark pupil or bright pupil tracking.

This kind of design is only feasible in the cases where there are more than one LCD active areas and there is sufficient space available on the cover glass to insert specific light indicators or IR LED systems. If the OEM will choose, for example to have a pillar-to-pillar seamless design with only one active area, this can become problematic for the driver monitoring system.

### SUMMARY

It is an object of the present disclose to provide a display with an improved backlight system.

This object is achieved by a display comprising a backlight unit with a backlight LED working in the visible spectrum and with an infrared LED placed in a similar manner in the display as the backlight LED. The claims include further developments and improvements of the present principles as described below.

According to a first aspect, a display device comprises a housing, a backlight unit with a backlight LED working in the visible spectrum, placed in the housing, a light diffuser placed in front of the backlight unit, an LCD layer placed in front of the light diffuser, and a cover glass placed in front of the LCD layer. Furthermore, the backlight unit comprises an infrared LED placed in a similar manner in the display as the backlight LED. The infrared LED placed in a similar manner in the display device as the backlight LED means that the IR LED may be placed in same positions as normally a backlight LED would be placed. It is understood that the disclosure discloses a mixture of backlight LED in the visible wavelength range and IR LED. Hence, in case the backlight unit would comprise a single backlight LED in the visible wavelength range, the display device would at least additionally comprise a single IR LED. For example, the IR LED may be placed in juxtaposition with the backlight LED working in the visible wavelength range. For example, the IR LED and the backlight LED can be placed adjacent to each other. It is understood that the backlight unit may comprise a plurality of backlight LEDs and/or a plurality of IR LEDs, e.g., an LED strip. It is understood that the infrared LED as well as the backlight LED are placed inside the mechanical housing such that emitted light from the respective LED falls onto the light diffuser.

The two distinct light sources, i.e., the IR LED and the backlight LED, will generate light, with totally different wavelengths and that is why, placing them in a similar manner in the display, would have no influence of either one's functionality and furthermore, the diffuser will ensure an even dispersion of light in both visible and invisible light spectrum. White LEDs, depending on what color temperature they have, they usually produce visible energy somewhere in the area of ˜480-600 nm and on the opposite end, IR LEDs, which will be used in this application, generate light in the 850-940 nm range. Due to the constructive material and properties, polarizers will have little to no effect on the optical transmittance properties in this wavelength. The same applies to the other components of the display. An advantage of the proposed solution is that it offers better luminance in the IR spectrum for a driver monitoring system. Furthermore, the solution contributes to the increasing demand of seamless integration of displays and camera systems. The IR light from the IR LED may then be used to have a proper illumination of a driver's or a passenger's face in a vehicle.

According to a first embodiment, the backlight LED and the IR LED are placed at a bottom of the housing, adjacent to each other and facing the diffuser. Some embodiments require an evenly distribution of LEDs behind the active area of the LCD. Such an embodiment benefits an increased brightness factor and may be beneficially used if a local dimming is needed. This embodiment proposes the mixture of backlight LEDs, e.g., white LEDs, with IR LEDs to achieve a relatively uniform distribution of light in both wavelengths.

According to a second embodiment of the present application, the backlight LED and the IR LED are placed at an edge of the display in a lateral position to the housing. Preferably, the backlight and the IR LED are arranged opposite each other such that they are facing each other. Such embodiment has the advantage to permit a very slim design of the final display device. Hence, such approach results in a space-saving embodiment.

According to a second aspect, a vehicle comprises a display device in accordance with one of the aforementioned embodiments.

### BRIEF DESCRIPTION OF THE FIGURES

Further features of the present disclosure will become apparent from the following description and the appended claims in conjunction with the figures.

FIG. 1 shows a schematical sketch of a display device known from the state of the art in a cross-sectional and exploded view,

FIG. 2 shows a schematical sketch of a display device in accordance with a first embodiment of the disclosure in a cross-sectional and exploded view, and

FIG. 3 shows a schematical sketch of a display device in accordance with a second embodiment of the disclosure in a cross-sectional and exploded view.

### DETAILED DESCRIPTION

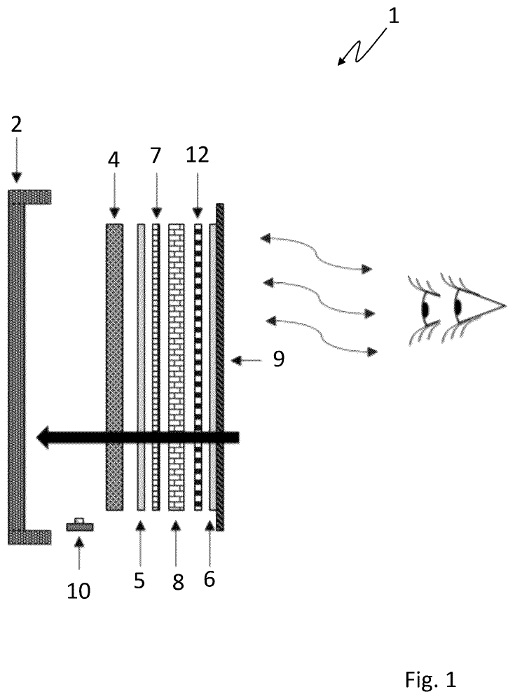

For a better understanding of the principles of the present disclosure, embodiments of the disclosure will be explained in more detail below with reference to the figures. Like reference numerals are used in the figures for the same or equivalent elements and are not necessarily described again for each figure. It is to be understood that the disclosure is not limited to the illustrated embodiments and that the features described may also be combined or modified without departing from the scope of the disclosure as defined in the appended claims. It should be further emphasized that the figures are not true to scale and that due to the nature of the figures, which are an exploded view, individual components of the embodiments of the display devices may be located in different locations as would be expected in a pure cross-sectional view. The black arrow in the FIGS. 1, 2 and 3 indicates the enclosement direction.

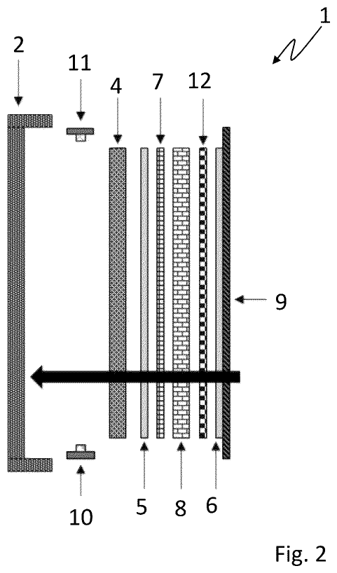

FIG. 2 shows a schematical sketch of a display device 1 in accordance with a first embodiment of the invention in cross-sectional view. The display device is an LCD device 1 that comprises a housing 2, a backlight unit with a light source working in the visible spectrum, here a backlight LED 10 working in the visible wavelength spectrum range, more precisely, a white LED stripe, a light diffuser 4, a first light polarizer 5 and a second light polarizer 6, a thin-film-transistor (TFT: thin-film-transistor) matrix 7, a liquid crystal structure layer 8 which is basically just an electronic controlled filter, a colour filter 12 and a cover glass 9.

The housing 2 forms a back cover of the display device 1 and offers space to accommodate the different components of the display device and hence in particular, the backlight unit, the light diffuser 4, the first light polarizer 5 and the second light polarizer 6, the thin-film-transistor (TFT: thin-film-transistor) matrix 7, the liquid crystal structure layer 8 and the colour filter 12. The cover glass 9 is used to close the housing 2 and to cover the components within the housing 1.

Starting from the cover glass 9 with a direction to a bottom of the housing 2, the second light polarizer 6, also referred to as front polarizer is placed behind the cover glass 9, the colour filter 12 is placed behind the second polarizer 6, the liquid crystal structure layer 8 is placed behind the colour filter 12, the TFT matrix 7 is placed behind the liquid crystal structure layer 8, the first polarizer 5 is placed behind the TFT matrix 7, the light diffuser 4 is placed behind the first polarizer 5 and the backlight unit is placed behind the light diffuser 4 and closest to the bottom of the housing 2. The backlight unit in addition to the backlight LED 10 working in the visible wavelength spectrum range comprises an infrared LED 11. The infrared LED 11 is placed in a similar manner in the display device 1 as the backlight LED 10.

In the embodiment shown in FIG. 2, the backlight LED 10 and the IR LED 11 are placed opposite each other at an edge of the display in a lateral position to the housing facing each other. Furthermore, the backlight LED 10 and the IR LED are directed to the light diffuser 4 (not shown in FIG. 2). In FIG. 2, each shown single LED represents a plurality of the same kind of LEDs arranged in a row, here an LED strip. Thus, the backlight LED 10 at the edge of the display represents a row of backlight LEDs, here a white LED strip, and the IR LEDs at the opposite side of the backlight LEDs represents a row of IR LEDs, here an infrared LED strip.

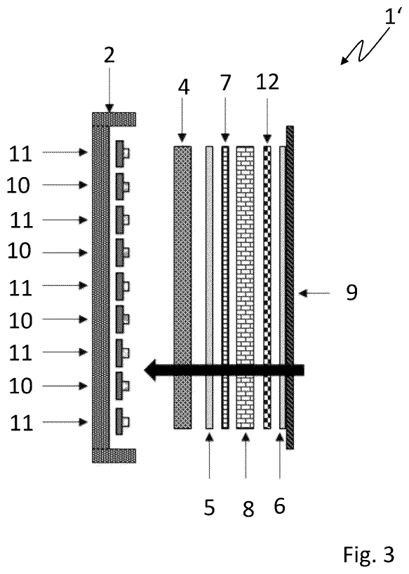

FIG. 3 shows a schematical sketch of a display device 1′ in accordance with a second embodiment of the disclosure. The only difference compared to the embodiment shown in FIG. 2 is that the backlight LED 10 and the IR LED 11 are placed at a bottom of the housing, adjacent to each other and directed to the diffuser. Here, the backlight unit comprises a plurality of backlight LEDs 10 in the visible wavelength range and a plurality of IR LEDs 11. As FIG. 3 shows a cross-sectional view through a schematic display, the LEDs, i.e., the backlight LEDs 10 and the IR LEDs 11 are placed in a matrix of LEDs arranged at the bottom of the housing 2 facing the diffuser 4. In FIG. 3, each shown LED represents a plurality of the same kind of LEDs arranged in a row of the matrix of the LEDs, i.e., an LED strip. Thus, a first row of the matrix is formed by IR LEDs, i.e., an IR LED strip, a second row by backlight LEDs, i.e., a white LED strip, and so on.

It is understood that the present application is not restricted to the above-mentioned embodiments as there exist further embodiments. For example, with regard to FIG. 3 the kinds of LEDs may be arranged such that not the rows, but the columns of the matrix may be represented by same kind of LEDs. Thus, a first column of the matrix is formed by IR LEDs, i.e., an IR LED strip, a second column by backlight LEDs, i.e., a white LED strip, and so on. Furthermore, there may exist embodiments in which, for example, each IR LED may has a neighbouring backlight LED in a left/right and up/down position and only in a diagonal direction the same kind of LED.

1. A display device, the display device comprising:
a housing,
a backlight unit with a backlight LED working in the visible wavelength spectrum, placed in the housing,
a light diffuser placed in front of the backlight unit,
an LCD structure layer placed in front of the light diffuser, and
a cover glass placed in front of the LCD structure layer,
wherein the backlight unit further comprises an infrared LED placed in a similar manner in the display device as the backlight LED.

2. The display device as claimed in claim 1, wherein the backlight LED and the IR LED are placed at a bottom of the housing, adjacent to each other and facing the light diffuser.

3. The display device as claimed in claim 1, wherein the backlight LED and the IR LED are placed at an edge of the display in a lateral position to the housing.

4. The display device as claimed in claim 3, wherein the backlight LED and the IR LED are placed opposite each other at an edge of the display in a lateral position to the housing.

5. A vehicle, the vehicle comprising:
a display device, the display device comprising:
a housing,
a backlight unit with a backlight LED working in the visible wavelength spectrum, placed in the housing,
a light diffuser placed in front of the backlight unit,
an LCD structure layer placed in front of the light diffuser, and
a cover glass placed in front of the LCD structure layer,
wherein the backlight unit further comprises an infrared LED placed in a similar manner in the display device as the backlight LED.
